(19) United States
(12) Patent Application Publication
(10) Pub. No.: US 2004/0155468 A1
(43) Pub. Date: Aug. 12, 2004

(54) Series and parallel combined dual power drive system

(76) Inventor: Tai-Her Yang, Dzan-Hwa (TW)

Correspondence Address: RABIN & BERDO, P.C., Suite 500, 1101 14th Street, N.W., Washington, DC, 20005, US

(21) Appl. No.: 10/364,391

(22) Filed: Feb. 12, 2003

(51) Int. Cl. H02P 9/00

(52) U.S. Cl. 290/40 C

(57) ABSTRACT

A series and parallel combined dual power drive system is the first system that provides the combined operation of a series drive system and a parallel drive system; the operation of the parallel drive system allows the engine power to drive a load at high power and high efficiency, and in case of a lighter load driven at low power and low rpm the operation, the series drive system operates to drive the lighter load, so to eliminate flaws of low efficiency and high pollution observed in the prior art.

### BACKGROUND OF THE INVENTION

(a) Field of the Invention

The present invention is related to a series and parallel combined dual power drive system, and more particularly, to one that allows load driven at high efficiency and high power by an engine, with lighter load to be driven by series drive system at low rpm and low power to effectively eliminate low efficiency and high pollution flaws observed with the engine driving at low power and low rpm.

(b) Description of the Prior Art

Conventionally, single power system is used in a sea craft or aircraft. In recent years, dual power drive system has attracted significant R&D inputs, particularly in the areas of a motor drive system containing internal combustion engine drive and battery power driven at the same time, for energy saving and pollution control. Dual power drive systems already having been developed include:

1. Series drive system: an engine is used to drive a generator, the generator in turn drives a motor to drive a load, the system is found with defective of excessively wild difference in efficiency of various full load rates;

2. Energy storage type series drive system: an engine is used to drive a generator, the generator in turn drives a motor to drive a load; part of the electric energy from the generator at light load is inputted into a battery for storage, and the stored electric energy is used to drive the motor to drive a load when the engine stops; and

3. Parallel drive system: an engine is used to directly drive a load while a motor is driven to charge a battery at light load, so that once the engine stops, the electric energy stored in the battery is used to drive the motor to drive a load while in case of a heavy load, the load is driven by the motor driven simultaneously by the engine and the battery; this type of system is found with defective that a battery having sufficient capacity for storage of electric energy is required.

### SUMMARY OF THE INVENTION

The primary purpose of the present invention is to provide a series and parallel combined dual power drive system giving at the same time features of combined operation of a series drive system and a parallel drive system so to permit the engine power driving a load at high power and high efficiency, and an electric energy storage battery becomes an optional item which may or may not be provided. Once a light load 108 is driven at low power and low rpm, the series drive system operates with a first electric engineering unit 101 driven by an engine set 100 to drive a motor to operate. Electric energy outputted by the motor is used to drive a second electric engineering unit 103 for the motor to engage in functional operation for driving a light load, thus to correct the low efficiency and high pollution of the engine in low power and low rpm drive.

### BRIEF DESCRIPTION OF THE DRAWINGS

FIG. 1 is a block chart of a preferred embodiment of the present invention.

FIG. 2 is another block chart of the preferred embodiment of the present invention.

### DETAILED DESCRIPTION OF THE PREFERRED EMBODIMENTS

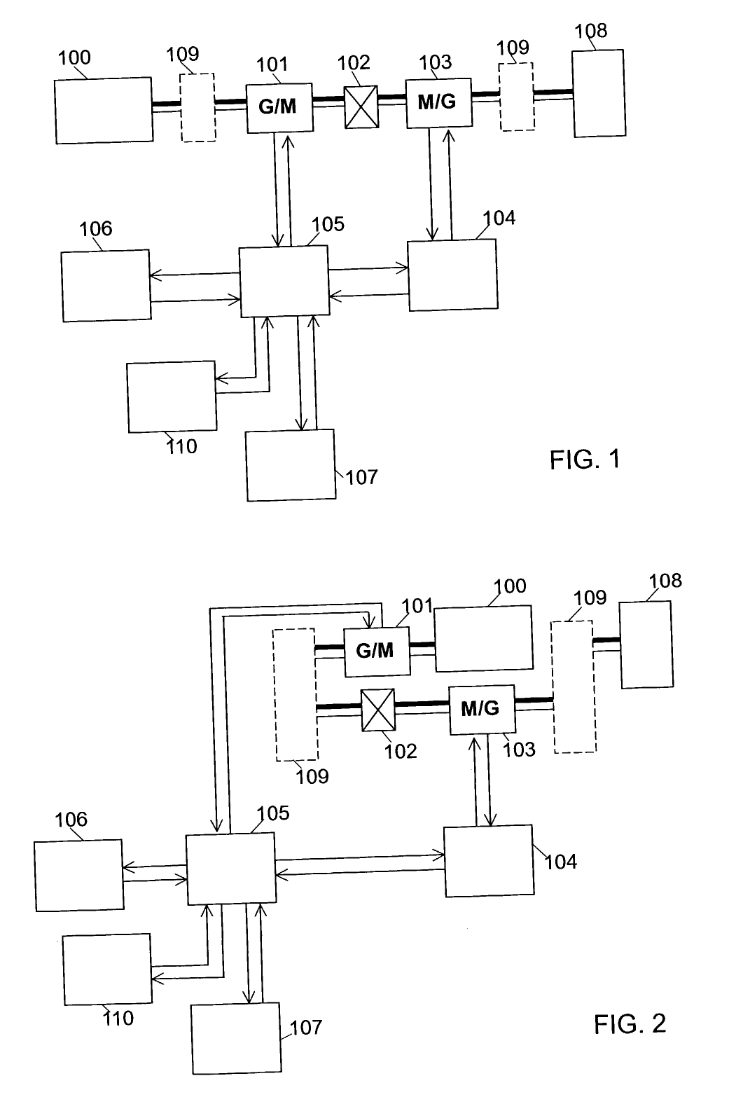

Referring to FIG. 1 for a block chart, wherein, a series and parallel combined dual power drive system of the present invention having a shaft from a first electric engineering unit and another shaft from a second electric engineering unit in series configuration, is essentially comprised of:

an engine set 100: relates to any type of internal combustion engine of the prior art;

the first electric engineering unit 101: comprised of an AC, or DC, brush or brushless rotary mechanism that functions as a generator, or can be converted into functioning as a motor or a generator;

a clutch 102: Related to one controlled by manual, mechanical force, air pressure, hydraulic flow, or electromagnetic force to transmit or to interrupt transmission of rotary mechanical kinetic;

the second electric engineering unit 103: comprised of an AC, or DC, brush or brushless rotary mechanism that functions as a motor, or can be converted into functioning as a motor or a generator;

a control unit 104 for the second electric engineering unit functioning as a motor drive: provided to control the first electric engineering unit 101 functioning as a generator, or to control an energy storage battery set 106 for controlling the revolving direction, rpm, torque and amperage of the second electric engineering unit 103 functioning as a motor;

a central control unit 105: comprised of solid-state, or electromechanical device, or chip and related software for being subject to the control by a manual control interface 107 to control operation of the series and parallel combined dual power drive system, the control unit 104 for the second electric engineering unit functioning as a motor, and feedback monitor and coordinated interaction among all units in the system;

an activating battery 110: comprised of a rechargeable battery of the prior art that is used to activate the engine set 100, or supply power to peripheral equipment;

the manual control interface 107: comprised of solid-state, or electromechanical device, or chip and related software to receive inputs of manual control to control the operation of the series and parallel combined dual power drive system;

a load 108: related to the load receiving inputs of rotary mechanical kinetic as required by a land, surface or air craft and industrial equipment; and

a transmission unit 109: comprised of any type of automatic, semi-automatic or manual transmission unit to be provided between the shaft of the engine set 100 and that of the first electric engineering unit 101, or between the shaft of the first electric engineering unit 101 and the input of the clutch 102, or between the output of the clutch 102 and the shaft of the second electric engineering unit 103, or between the shaft of the second electric engineering unit 103 and the load 108.

The serial and parallel combined dual power drive system provides its primary functions including but not limited to the followings:

Output from the engine set 100 drives the first electric engineering unit 101 functioning as a generator; the clutch 102 is provided between the shaft from the generator comprised of the first electric engineering unit 101 and the shaft of the motor comprised of the second electric engineering unit 103; output from the second electric engineering unit 103 functioning as the motor drives the load 108; the clutch 102 is not copulated when the load 108 is in state of a light load; output from the engine set 100 at low rpm drives the first electric engineering unit 101 functioning as the generator to produce electricity; then the electricity produced by the generator comprised of the first electric engineering unit 101 drives the motor comprised of the second electric engineering unit 103 and further to drive the load 108 in a status wherein the nature of the operation of the system is of a series drive system; and

the clutch 102 is closed in the event that the load 108 relates to a heavy load, and the load 108 is driven by the kinetic outputted from the engine set 100.

Furthermore, the series and parallel combined dual power drive system provides its secondary functions including but not limited to the following optional functions that may be or may not be required:

the clutch 102 is not copulated, instead, the generator comprised of the first electric engineering unit 101 is converted into functioning as a motor and is driven by the electricity supplied by the activating battery 110 to activate the revolution by the engine set 100;

the clutch 102 is not closed, instead, the motor comprised of the second electric engineering unit 103 revolves in the opposite direction to exercise reverse for the craft; and

the clutch 102 is closed, and the load 108 is driven by the engine set 100 to exercise the reverse for the craft.

On considerations of the urban environment, the demands of power drive when the engine fails, and the demand of energy storage for braking by regeneration kinetic, an energy storage battery set 106 may be added to the series and parallel combined dual power drive system for the energy storage battery set 106 to be recharged by the electricity generated by the first electric engineering unit 101 operating as a generator as driven by the power from the engine set 100, including that

(1) when the system is in series operation and the load 108 is related to a light load, also the first electric engineering unit 101 operates as a generator, the electricity generated is supplied to drive the second electric engineering unit 103 functioning as a motor to drive the load, and certain portion of the electricity is supplied to recharge the energy storage battery set 106 for the engine set 100 is capable of operating in a work range with higher energy efficiency;

(2) when the load 108 is directly driven by the power from the engine set 100, the first electric engineering unit 101 as drive operates as a generator to deliver certain portion of its electricity to recharge the energy storage battery set 106 so that the engine set 100 is capable of operating in a work range with higher energy efficiency;

(3) the electricity outputted from the generator comprised of the first electric engineering unit 101 as driven by the engine set 100 is used to recharge the energy storage battery set 106; and

(4) while exercising the braking, the energy storage battery set 106 is recharged by either or both of the first electric engineering unit 101 and the second engineering unit 103 functioning as the generator, or an electricity consumption load is added to provide regeneration kinetic feedback to the braking.

Output of electricity from the energy storage battery set 106 is used for the following purposes:

(1) to replace as an alternative the activating battery 110 to drive the first electric engineering unit 101 to function as a motor for activating the engine set 100;

(2) to drive the second electric engineering unit 103 to function as a drive motor to drive the load 108;

(3) to supply power to other loads;

(4) to drive by using the electricity from the energy storage battery set 106 the first electric engineering unit 101, or the second electric engineering unit 103 to function as a motor to support the engine set 100 jointly in driving the load 108; or

(5) to drive by using the electricity from the energy storage battery set 106 the first electric engineering unit 101, and the second electric engineering unit 103 to function each as a motor to support the engine set 100 jointly in driving the load 108.

Now referring to FIG. 2 for a block chart of the preferred embodiment of the present invention, the shaft of the engine set and that of the second electric engineering unit indicates a parallel structure.

The series and parallel combined dual power drive system for providing the combined operation of a series drive system and a parallel drive system to eliminate flaws of low efficiency and high pollution observed in the prior art by having its operation of the parallel drive system to allow the engine power drive a load at high power and high efficiency with an optional storage battery, and having the engine set 100 to drive the first electric engineering unit 101 functioning as a generator to output electricity for driving the second electric engineering unit 103 to function as a motor to drive a lighter load 108 at low power and low rpm, is innovative with precise functions, and application is duly filed accordingly.

1. A series and parallel combined dual power drive system giving at the same time features of combined operation of a series drive system and a parallel drive system so to permit the engine power driving a load at high power and high efficiency, and an electric energy storage battery becomes an optional item which may or may not be provided; once a light load 108 is driven at low power and low rpm, the series drive system operates with a first electric engineering unit 101 driven by an engine set 100 to drive a motor to operate; and the electric energy outputted by the motor being used to drive a second electric engineering unit 103 for the motor to engage in functional operation for driving a light load, thus to correct the low efficiency and high pollution of the engine in low power and low rpm drive.

2. A series and parallel combined dual power drive system as claimed in claim 1, wherein, a shaft from a first electric engineering unit and another shaft from a second electric engineering unit in series configuration, is essentially comprised of:
an engine set 100: relates to any type of internal combustion engine of the prior art;
the first electric engineering unit 101: comprised of an AC, or DC, brush or brushless rotary mechanism that functions as a generator, or can be converted into functioning as a motor or a generator;
a clutch 102: Related to one controlled by manual, mechanical force, air pressure, hydraulic flow, or electromagnetic force to transmit or to interrupt transmission of rotary mechanical kinetic;
the second electric engineering unit 103: comprised of an AC, or DC, brush or brushless rotary mechanism that functions as a motor, or can be converted into functioning as a motor or a generator;
a control unit 104 for the second electric engineering unit functioning as a motor drive: provided to control the first electric engineering unit 101 functioning as a generator, or to control an energy storage battery set 106 for controlling the revolving direction, rpm, torque and amperage of the second electric engineering unit 103 functioning as a motor;
a central control unit 105: comprised of solid-state, or electromechanical device, or chip and related software for being subject to the control by a manual control interface 107 to control operation of the series and parallel combined dual power drive system, the control unit 104 for the second electric engineering unit functioning as a motor, and feedback monitor and coordinated interaction among all units in the system;
an activating battery 110: comprised of a rechargeable battery of the prior art that is used to activate the engine set 100, or supply power to peripheral equipment;
the manual control interface 107: comprised of solid-state, or electromechanical device, or chip and related software to receive inputs of manual control to control the operation of the series and parallel combined dual power drive system;
a load 108: related to the load receiving inputs of rotary mechanical kinetic as required by a land, surface or air craft and industrial equipment; and
a transmission unit 109: comprised of any type of automatic, semi-automatic or manual transmission unit to be provided between the shaft of the engine set 100 and that of the first electric engineering unit 101, or between the shaft of the first electric engineering unit 101 and the input of the clutch 102, or between the output of the clutch 102 and the shaft of the second electric engineering unit 103, or between the shaft of the second electric engineering unit 103 and the load 108.

3. A series and parallel combined dual power drive system as claimed in claim 2, wherein, its primary functions including but not limited to the followings:
Output from the engine set 100 drives the first electric engineering unit 101 functioning as a generator; the clutch 102 is provided between the shaft from the generator comprised of the first electric engineering unit 101 and the shaft of the motor comprised of the second electric engineering unit 103; output from the second electric engineering unit 103 functioning as the motor drives the load 108; the clutch 102 is not copulated when the load 108 is in state of a light load; output from the engine set 100 at low rpm drives the first electric engineering unit 101 functioning as the generator to produce electricity; then the electricity produced by the generator comprised of the first electric engineering unit 101 drives the motor comprised of the second electric engineering unit 103 and further to drive the load 108 in a status wherein the nature of the operation of the system is of a series drive system; and
the clutch 102 is closed in the event that the load 108 relates to a heavy load, and the load 108 is driven by the kinetic outputted from the engine set 100.

4. A series and parallel combined dual power drive system as claimed in claim 2, wherein, its secondary functions including but not limited to the following optional functions that may be or may not be required:
the clutch 102 is not copulated, instead, the generator comprised of the first electric engineering unit 101 is converted into functioning as a motor and is driven by the electricity supplied by the activating battery 110 to activate the revolution by the engine set 100;
the clutch 102 is not closed, instead, the motor comprised of the second electric engineering unit 103 revolves in the opposite direction to exercise reverse for the craft; and
the clutch 102 is closed, and the load 108 is driven by the engine set 100 to exercise the reverse for the craft.

5. A series and parallel combined dual power drive system as claimed in claim 2, wherein, an energy storage battery set 106 may be added to the series and parallel combined dual power drive system for the energy storage battery set 106 to be recharged by the electricity generated by the first electric engineering unit 101 operating as a generator as driven by the power from the engine set 100, including that:
(1) when the system is in series operation and the load 108 is related to a light load, also the first electric engineering unit 101 operates as a generator, the electricity generated is supplied to drive the second electric engineering unit 103 functioning as a motor to drive the load, and certain portion of the electricity is supplied to recharge the energy storage battery set 106 for the engine set 100 is capable of operating in a work range with higher energy efficiency;
(2) when the load 108 is directly driven by the power from the engine set 100, the first electric engineering unit 101 as drive operates as a generator to deliver certain portion of its electricity to recharge the energy storage battery set 106 so that the engine set 100 is capable of operating in a work range with higher energy efficiency;
(3) the electricity outputted from the generator comprised of the first electric engineering unit 101 as driven by the engine set 100 is used to recharge the energy storage battery set 106; and
(4) while exercising the braking, the energy storage battery set 106 is recharged by either or both of the first electric engineering unit 101 and the second engineering unit 103 functioning as the generator, or an electricity consumption load is added to provide regeneration kinetic feedback to the braking.

6. A series and parallel combined dual power drive system as claimed in claim 5, wherein, the Output of electricity from the energy storage battery set 106 is used for the following purposes
(1) to replace as an alternative the activating battery 110 to drive the first electric engineering unit 101 to function as a motor for activating the engine set 100;
(2) to drive the second electric engineering unit 103 to function as a drive motor to drive the load 108;
(3) to supply power to other loads;
(4) to drive by using the electricity from the energy storage battery set 106 the first electric engineering unit 101, or the second electric engineering unit 103 to function as a motor to support the engine set 100 jointly in driving the load 108; or
(5) to drive by using the electricity from the energy storage battery set 106 the first electric engineering unit 101, and the second electric engineering unit 103 to function each as a motor to support the engine set 100 jointly in driving the load 108.
